(19) United States
(12) Patent Application Publication
(10) Pub. No.: US 2005/0219370 A1
(43) Pub. Date: Oct. 6, 2005

(54) Digital camera equipped with surveillance and burglarproof functions

(76) Inventor: Yi-Chia Liao, Miao-Li Hsien (TW)

Correspondence Address: BIRCH STEWART KOLASCH & BIRCH, PO BOX 747, FALLS CHURCH, VA, 22040-0747, US

(21) Appl. No.: 10/811,929

(22) Filed: Mar. 30, 2004

(51) Int. Cl. H04N 5/225

(52) U.S. Cl. 348/207.99

(57) ABSTRACT

A digital camera equipped with surveillance and burglarproof functions includes a host and a picture taking device that are separable. The host may be placed in a hidden location in a house. The picture taking device may be used to take pictures for surveillance purpose. The picture taking device and the host may also be coupled to become one body to function as a digital camera for taking pictures directly. The picture taking is performed one by one in a static fashion to produce clear images.

### FIELD OF THE INVENTION

The present invention relates to a digital camera and particularly to a digital camera equipped with surveillance and burglarproof functions.

### BACKGROUND OF THE INVENTION

Digital camera differs from the conventional camera mainly in the image forming media. The conventional camera forms images on films, while the digital camera forms images on a charge-coupled device (CCD) that is a photosensitive semiconductor. CCD transforms the light passing through the lens to charged signals of different intensity. And the signals are converted to digital data that are stored as files readable by computers.

The picture taken by the digital camera is a static image. It is presented one frame at a time. The image and picture is clear. A great added value for the digital camera may be created if it can be adapted for burglarproof use. Such an approach can improve the drawbacks occurred to the conventional burglarproof devices. As the conventional burglarproof devices mostly adopt dynamic and continuous picture taking, the resulting dynamic images are often blurred and fuzzy.

### SUMMARY OF THE INVENTION

Therefore the primary object of the invention is to provide a digital camera that equips with surveillance and burglarproof functions. In one aspect, the digital camera according to the invention includes a host and a picture taking device that are separable for surveillance use. When in use for burglarproof purpose, the host may be placed in a hidden location in the house while the picture taking device functions as a surveillance picturing device. When use as a digital camera, the picture taking device and the host are coupled together for taking pictures.

Another object of the invention is to provide a digital camera that equips with surveillance and burglarproof functions so that it can take picture one by one in a static fashion to produce clear and high quality images.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of the present invention.

FIG. 2 is a control circuit block diagram of the picture taking device of the invention.

FIG. 3 is a control circuit block diagram of the host of the invention.

### DETAILED DESCRIPTION OF THE PREFERRED

### Embodiment

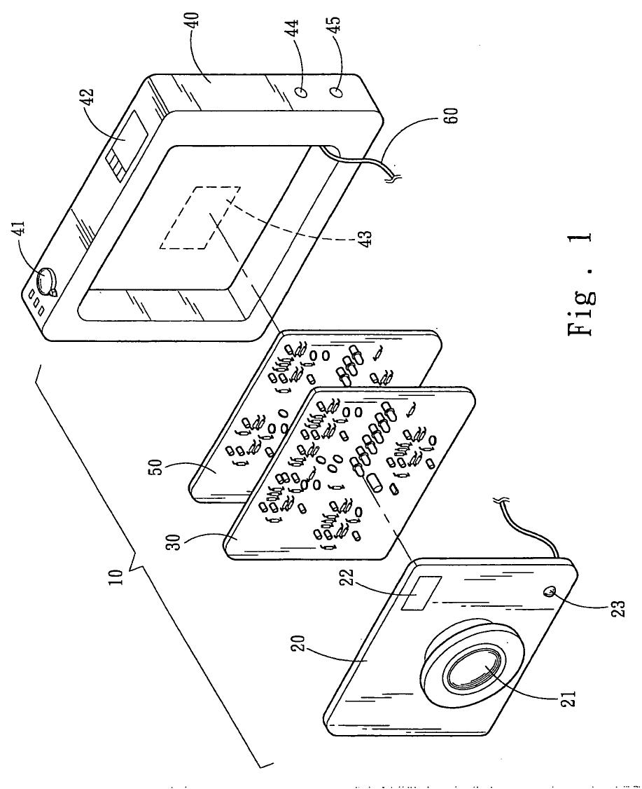

Please referring to FIG. 1, the digital camera 10 equipped with surveillance and burglarproof functions according to the invention includes a picture taking device 20 and a host 40 that are separable or coupled together. The picture taking device 20 includes a lens 21 which consists of CCD sensor (charged coupled device) and a lens that may be selectively a telephoto lens, a standard lens or a wide-angle lens. It adopts photosensitive electronic principle to capture images. Namely, the sensors receive light and generate electrons at a quantity proportional to the intensity of the light. The picture taking device 20 includes an optical viewfinder 22 to enable users to see the images to be taken through the lens 21, and at least one burglarproof sensor 23 to automatically detect signals of human body temperature or movement. The burglarproof sensor 23 may be an electronic human sensor or an infrared sensor.

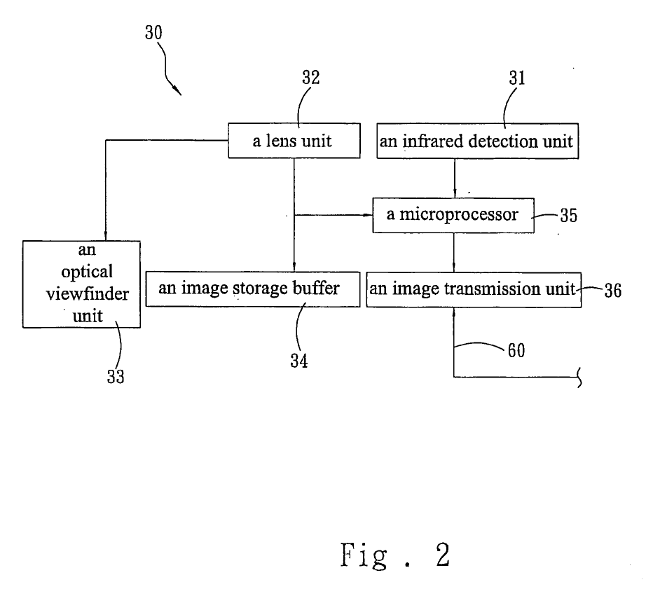

Refer to FIG. 2 for the control circuit block diagram of the picture taking device of the invention. The picture taking device 20 contains a first control circuit 30 which includes an infrared detection unit 31 to receive signals from the burglarproof sensor 23 and emit signals to a microprocessor 35 which issues signals to an image transmission unit 36; a lens unit 32 to receive the signals from the lens 21 and transfer the signals to the microprocessor 35 and an image storage buffer 34; an optical viewfinder unit 33 to display the signals of the lens unit 32; the image storage buffer 34 to temporarily store the signals taken by the lens unit 32; the microprocessor 35 to receive the signals from the infrared detection unit 31 and the lens unit 32, and issue signals to the image transmission unit 36; the image transmission unit 36 to receive the signals from the microprocessor 35 and transfer the signals in the image storage buffer 34 to a memory unit 57 in the host 40 for storing.

Referring to FIGS. 1 and 2, the host 40 is connected to the picture taking device 20 through a transmission line 60 so that they may be separated or coupled together. The host 40 includes a manual shutter button 41 which functions like the shutter release of the digital camera 10 for activating the picture taking device 20 to take pictures and has different operation modes for selection, an operation display window 42 to display the operation mode of the manual shutter button 41, a LCD viewing window 43 to enable users to directly see the picture taken, at least one set of video/audio output jack 44 for connecting to a TV set, and a video/audio input jack 45 for connecting to a power supply to provide electric power needed.

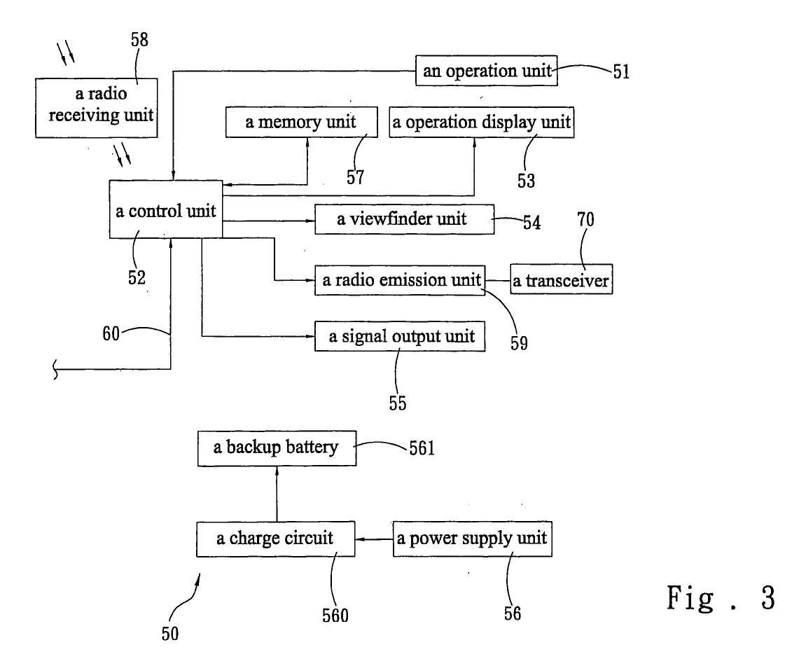

Refer to FIG. 3 for the control circuit block diagram of the host. The host 40 contains a second control circuit 50 which includes an operation unit 51 connecting to the manual shutter button 41 and issuing operation signals to a control unit 52, a operation display unit 53 to receive the operation signals from the control unit 52 and display signal conditions on the operation display window 42, a viewfinder unit 54 to receive signals from the control unit 52 and transfer the signals to the LCD viewing window 43 to allow users to directly see the pictures taken, a signal output unit 55 to receive the signals from the control unit 52 and transfer the signals to the TV set, a power supply unit 56 to connect to a charge circuit 560 and a backup battery 561 to provide electric power needed, a memory unit 57 to store the signals conditions of the control unit 52, and receive the signals temporarily stored in the image storage buffer 34, a radio receiving unit 58 to receive external remote control signals and transmit the signals to the control unit 52, and a radio emission unit 59 to receive the signals from the control unit 52 and emit radio signals to a transceiver 70 such as a USB transceiver box or the like. Images may be transmitted to a computer through USB signal transmission. The control unit 52 receives signals from the image transmission unit 36 and the radio remote control signals from the radio emission unit 59, and transmits signals to various units.

The digital camera 10 thus constructed has enhanced functions and can overcome the drawbacks of single function occurred to the conventional digital cameras. The picture taking device 20 and the host 40 may be separated or coupled together. Namely, they may be coupled to become one body and function as the digital camera 10 for picture taking during travel and trips outdoors. When use for burglarproof purpose, the picture taking device 20 and the host 40 may be separated. For instance, the picture taking device 20 may be placed on a location in the house where intruders are likely to enter to take pictures, and the burglarproof sensor 23 can detect the intrusion to trigger picture taking. The burglarproof sensor 23 may have different detection angles for selection (such as 15, 30, 60, 90, 120 degrees) to enhance the surveillance effectiveness. The host 40 may be linked to the picture taking device 20 through the transmission line 60 so that they may be separated and mounted on hidden locations. Therefore the host 40 may be hidden in any desired location in the house and remote from the picture taking device 20. In other words, even if the intruders detect the picture taking device 20, they cannot find out the location of the host 40. Thus the host 40 may be prevented from being sabotaged, and the burglarproof function may be maintained intact.

In addition, the second control circuit 50 of the host 40 includes the radio receiving unit 58 or radio emission unit 59. The radio receiving unit 58 can receive external remote signals to activate the control unit 52 in the host 40. When the control unit 52 receives the signals of the infrared detection unit 31 that indicate invasion of intruders occurs, the picture signals being taken will be emitted by radio transmission to avoid the host 40 being discovered and destroyed and lost of burglarproof function. The invention adopts the static picture taking approach. The pictures are taken one by one in a static fashion. It is different from the dynamic picture taking of the conventional surveillance burglarproof devices. Moreover, the pictures taken by the invention are stored in the memory. The resolution of the pictures may be adjusted as desired to get clearer pictures for identification.

Furthermore, the invention can transmit the signal to TV sets or to a computer through the transceiver 70 to enhance practicality.

1. A digital camera equipped with surveillance and burglarproof functions comprising a picture taking device and a host;
wherein the picture taking device contains a first control circuit which includes an infrared detection unit, a lens unit, an optical viewfinder unit, an image storage buffer, a microprocessor and an image transmission unit;
wherein the infrared detection unit generates signals which are transmitted to the microprocessor, the microprocessor issues signals to the image transmission unit;
the lens unit generates signals which are transmitted to the microprocessor and the image storage buffer;
the optical viewfinder unit displays the signals of the lens unit;
the image storage buffer stores temporarily the signals captured by the lens unit;
the microprocessor receives the signals from the infrared detection unit and the lens unit and transfers the signals to the image transmission unit; and
the image transmission unit receives the signals from the microprocessor and transmits the signals to the image storage buffer;
wherein the host contains a second control circuit which includes an operation unit, an operation display unit, a viewing unit, a signal output unit, a power supply unit, a memory storage unit, a radio receiving unit, a radio emission unit and a control unit;
wherein the operation unit generates operation signals which are transferred to the control unit;
the operation display unit receives the operation signals from the control unit;
the viewing unit receives signals from the control unit;
the signal output unit receives the signals from the control units;
the power supply unit is connected to a charge circuit and a backup battery to supply electric power required;
the memory storage unit stores signal conditions of the control unit and receives the signals from the image storage buffer and stores the signals;
the radio receiving unit receives the signals from the infrared detection unit and transfers the signals to the control unit;
the radio emission unit receives the signals from the control unit and emits the signals by radio; and
the control unit receives the signals from the image transmission unit and remote detection radio signals emitted by the radio emission unit, and transmits the signals to other units.

2. The digital camera of claim 1, wherein the picture taking device has a burglarproof sensor and an optical viewfinder.

3. The digital camera equipped with surveillance and burglarproof functions of claim 2, wherein the burglarproof sensor is an electronic human body sensor.

4. The digital camera equipped with surveillance and burglarproof functions of claim 2, wherein the burglarproof sensor is an infrared sensor.

5. The digital camera equipped with surveillance and burglarproof functions of claim 1, wherein the host further includes a manual shutter button, an operation display window, a LCD viewing window, a video/audio output jack and a video/audio input jack.

6. The digital camera equipped with surveillance and burglarproof functions of claim 1, wherein the radio emission unit is connected to a transceiver.
